(19) United States
(12) Patent Application Publication
(10) Pub. No.: US 2011/0194825 A1
(43) Pub. Date: Aug. 11, 2011

(54) METHOD OF FORMING AN OPTICAL FIBER BUFFER TUBE

(76) Inventor: Donald Ray Parris, Newton, NC (US)

(21) Appl. No.: 12/703,384

(22) Filed: Feb. 10, 2010

(51) Int. Cl. G02B 6/44; B65H 81/06

(52) U.S. Cl. 385/109; 156/185

(57) ABSTRACT

A method of forming an optical fiber buffer tube including the steps of providing a length of pre-shrunk tape having a predetermined width and thickness, forming the tape into a tube around at least one optical fiber, coating the formed tube with a molten material to close the tube, and cooling the molten material to maintain the shape of the tube. The method further includes calibrating the outer diameter of the coated tube during the cooling step by restraining the coated tube against outward radial expansion. An optical fiber buffer tube constructed according to the method is further provided.

### TECHNICAL FIELD AND BACKGROUND OF THE INVENTION

1. Field of the Invention

The present invention relates generally to the field of optical fiber cable construction, and more particularly, to a method of forming an optical fiber buffer tube including forming a pre-shrunk tape into a tube around at least one optical fiber, coating the tape with a layer of molten material to surround the tube, and cooling the molten material to close and maintain the shape of the tube.

2. Background of the Invention

Certain types of loose tube optical fiber cables include a plurality of optical fibers, arranged either individually or in a ribbon matrix, loosely disposed within a buffer tube. Known to those skilled in the art, a buffer tube is the primary structure for protecting the optical fibers residing therein, and is typically made from materials having a high Young's modulus to provide tensile and compressive resistance against such loads.

Conventionally, buffer tubes are formed by an extrusion process in which one or more materials in molten form are extruded around the optical fibers in the shape of a complete tube. Disadvantageously, as the molten material cools, the molecules oriented longitudinally in their molten state become “frozen” to some extent in this oriented state. This can later lead to post-extrusion shrinkage if the buffer tubes are heated and allowed to reorient to a preferred non-oriented state, causing post-extrusion shrinkage in the buffer tube and a resultant increase in excess fiber length (EFL). To address post-extrusion shrinkage, buffer tubes are often secured to strength members or other structures (e.g. such as within closures) capable of controlling the shrinkage. Another solution includes extruding and processing buffer tubes at a reduced rate, allowing time for the molten material to completely cool and crystallize. While technically feasible, this solution is not economically feasible.

Accordingly, to overcome the disadvantages of the prior art solutions, disclosed herein are buffer tube processing methods for producing loose tube cables having buffer tubes that are not susceptible to post-extrusion shrinkage, advantageously allowing these cables to be routed inside closures without restraint and without excessive low temperature optical attenuation increases. The processing methods disclosed herein are further advantageous with regard to their simplicity, durability and production rate.

### BRIEF SUMMARY OF THE INVENTION

To overcome the disadvantages of the prior art, in one embodiment, a method of forming an optical fiber buffer tube is provided including the steps of providing a length of pre-shrunk tape having a predetermined width and thickness, forming the tape into a tube around at least one optical fiber, coating the formed tube with a molten material to close the tube, and cooling the molten material to maintain the shape of the formed tube. In a further embodiment, the step of cooling the molten material includes passing the coated tube through a water trough under vacuum and calibrating the outer diameter of the coated tube by passing the tube through a series of linearly-arranged, spaced-apart calibrating disks, each of the disks defining an opening therethrough having a diameter about equal to, or slightly larger than, the outer diameter of the tube subsequent to coating such that the tube is restrained against outward radial expansion during the curing step.

In a further embodiment, the cured molten material surrounding the tube has a wall thickness less than the thickness of the tape, such that the dominant portion of the buffer tube wall thickness is made up of the pre-shrunk material to resist shrinkage of the buffer tube during curing and subsequent thereto. The cured molten material preferably makes up about 50% or less of the total buffer tube wall thickness, more preferably about 25% or less of the total buffer tube wall thickness, and even more preferably about 10% or less of the total buffer tube wall thickness. In the preferred embodiment, the cured molten material surrounds the outer surface of the formed tube and has a generally uniform wall thickness to provide a circular buffer tube cross-section. In an alternative embodiment, the formed tube may be internally coated to maintain and close the tube. Suitable materials for the pre-shrunk tape and molten material include, but are not limited to, polyethylene, polypropylene, polybutylene terephthalate, and polyethylene terephthalate.

In a further embodiment, the at least one optical fiber is loosely encased within the formed tube within a water blocking agent, such as a soft, thixotropic filling material. The at least one optical fiber may include a plurality of individual optical fibers or fibers arranged in a ribbon matrix. Additional elements including compressive and tensile strength members known to those skilled in the art may be included in the cable construction. In a further embodiment, the molten material may include a colorant for color-coding the buffer tube.

In a further embodiment, an extrusion vacuum calibrator is provided including a plurality of linearly-arranged, spaced apart calibrating disks, each of the disks including a hole defined therethrough having a diameter about equal to, or slightly larger, than the outer diameter of the tube subsequent to coating to control the outer diameter of the coated tube during cooling by restraining the coated tube against outward radial expansion. The disks may be more closely spaced apart proximate the entry side of the calibrator, where greater control of the outer diameter of the coated tube is required to maintain the shape, and spaced further apart from one another proximate the exit side of the calibrator, where less radial control is required. The calibrator may further include a water trough directing cooling water to the buffer tube for cooling the molten material and passing the buffer tube therethrough under vacuum.

Additional features and advantages of the invention will be set forth in the detailed description which follows, and in part will be readily apparent to those skilled in the art from that description or recognized by practicing the invention as described herein.

### BRIEF DESCRIPTION OF THE DRAWINGS

These and other features, aspects and advantages of the present invention are better understood when the following detailed description of the invention is read with reference to the accompanying drawings, in which:

FIG. 1 is a perspective view of an exemplary optical fiber cable including a buffer tube constructed according to a method provided herein;

FIG. 2 is a cross-sectional view of a buffer tube constructed according to a method provided herein;

FIG. 3 is a schematic diagram illustrating the apparatus for performing the method provided herein;

FIG. 4 is a perspective view of a calibrator apparatus illustrating the interior construction;

FIG. 5 is a perspective view of a portion of the calibrator illustrating the entry side of the apparatus; and

FIG. 6 is a side elevation view of a portion of the calibrator illustrating the spacing of the calibration disks.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention.

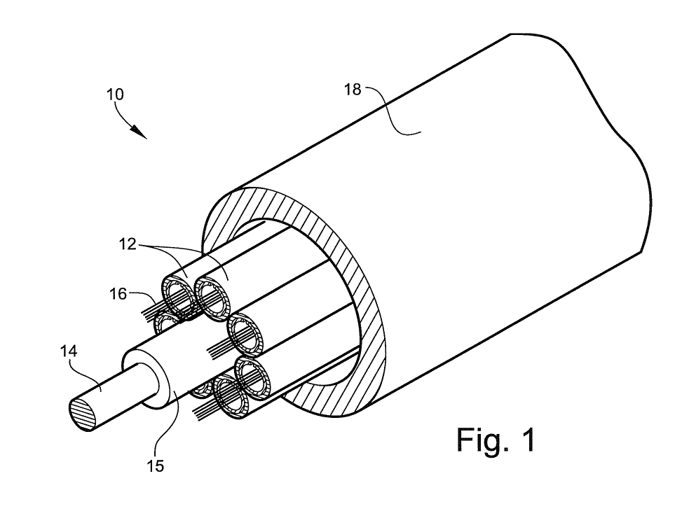

Referring to FIG. 1, a non-limiting example of a portion of an optical fiber cable including a buffer tube processed according to a method disclosed herein is illustrated generally at reference numeral 10. The cable 10 includes a plurality of buffer tubes 12 axially stranded about a central strength member 14, separated therefrom by a coating 15 that buffers contact between the buffer tubes 12 and the central strength member 14, and provides circumferential spacing for the proper placement of the buffer tubes 12. As known in the art, the central strength member 14 provides axial compression and tensile strength to the cable 10. Each of the individual buffer tubes 12 includes a plurality of optical fibers loosely disposed therein, such as individual or ribbonized optical fibers. The optical fibers 16 are preferably encased within a water blocking agent. The cable is surrounded by a sheath 18 that maintains the internal elements and their respective positions, and provides protection to the cable. It should be understood that the cable can include additional and/or alternative components without departing from the spirit and scope of the invention.

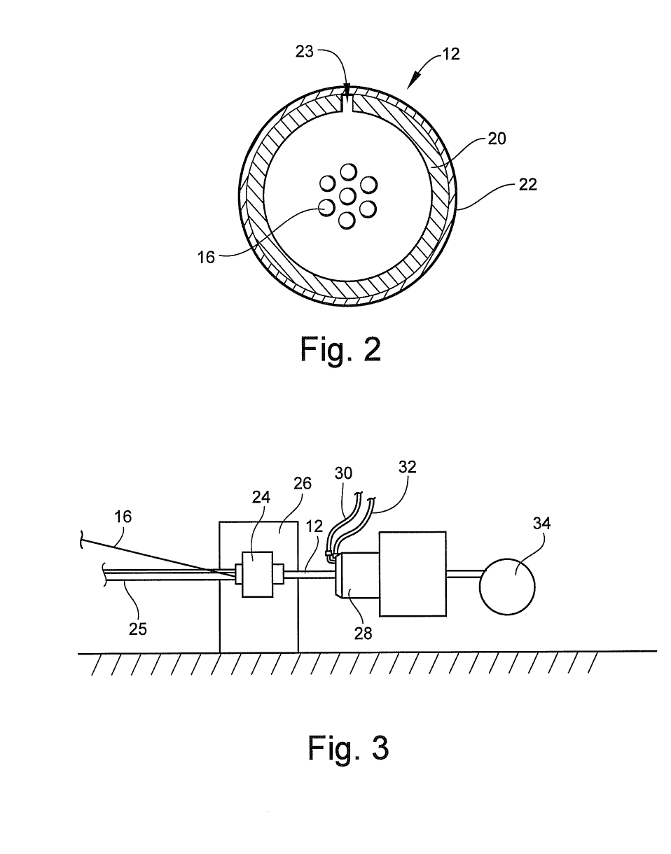

Referring to FIG. 2, a cross-sectional view of one of the buffer tubes removed from the cable 10 is shown to illustrate the buffer tube construction. The buffer tube 12 is generally circular in cross-section so as not to provide a preferential bend in the cable 10. The buffer tube 12 defines a wall thickness composed of a pre-shrunk plastic tape formed into a tube 20 and coated with a surrounding layer of the same or like material, referred to herein as the “coating” 22, applied in a molten state and cooled to form a solid buffer tube having a high Young's modulus, as described in detail below with regard to the method. The buffer tube 12 includes a seam 23, shown exaggerated for illustration purposes, as a result of folding the generally planar tape into a tube 20. The coating 22 surrounds the formed tube 20 and closes the tube by either maintaining the edges of the seam together or filling the seam.

The coating 22, i.e. cooled molten material, preferably makes up about 50% or less of the total buffer tube wall thickness, more preferably about 25% or less of the total buffer tube wall thickness, and even more preferably about 10% or less of the total buffer tube wall thickness. In this regard, the dominant portion of the buffer tube 12 is made up of the pre-shrunk tape, controlling the shrinkage of the buffer tube 12. In the preferred embodiment, the coating 22 surrounds the outer surface of the formed tube and has a generally uniform wall thickness to provide a circular buffer tube cross-section whose outer diameter is defined by the coating. In an alternative embodiment, the formed tube 20 may be internally coated to maintain and close the tube 20.

Suitable materials for the pre-shrunk tape and molten material include, but are not limited to, polyethylene, polypropylene, polybutylene terephthalate, and polyethylene terephthalate, among other plastics and like materials. The pre-shrunk tape may alternatively include an organic/inorganic composite having directionally oriented components that preferentially increase crush resistance. In the preferred embodiment, the pre-shrunk tape material has minimal or no post-manufacturing shrinkage and a low coefficient of thermal expansion/contraction. This may be achieved by “pre-shrinking” a plastic material and/or by including materials and dimensions that have low shrinking forces.

The preferred process for forming the optical fiber buffer tube 12 includes the steps of providing a length of pre-shrunk tape having a predetermined width and thickness, forming the tape into a tube around at least one optical fiber, coating the tube with a molten material to close and surround the tube, and cooling the molten material to maintain the shape of the tube. The step of cooling the molten material comprises passing the coated tube through a water trough under vacuum, and calibrating or controlling the outer diameter of the coated tube by passing the coated tube through a series of linearly-arranged, spaced-apart calibrating disks, each of the disks defining an opening therethrough having a predetermined diameter about equal to, or slightly larger than, the outer diameter of the coated tube to restrain the coated tube against outward radial expansion during cooling.

Referring to FIG. 3, the apparatus for processing the buffer tube 12 is illustrated. As shown, the pre-shrunk tape 25 and at least one optical fiber 16 taken from payoffs (not shown) under tension such as through a capstan (not shown) are brought together within a crosshead 24 of an extruder 26. The crosshead 24 is configured to form the generally planar tape 25, shown with an exaggerated dimension to illustrate a width and thickness, into a tube having the fibers loosely disposed therein, and the coating is applied as the formed tube passes through the extruder 26. The crosshead 24 may further function to inject a water blocking agent. In the extruder 26, the coating 22 is extruded in a molten state around the outer circumference of the formed tube 20 continuously along its length, substantially uniformly encasing the formed tube as it passes through the extruder 26 and forming a buffer tube that has a uniform cross-sectional diameter along its length.

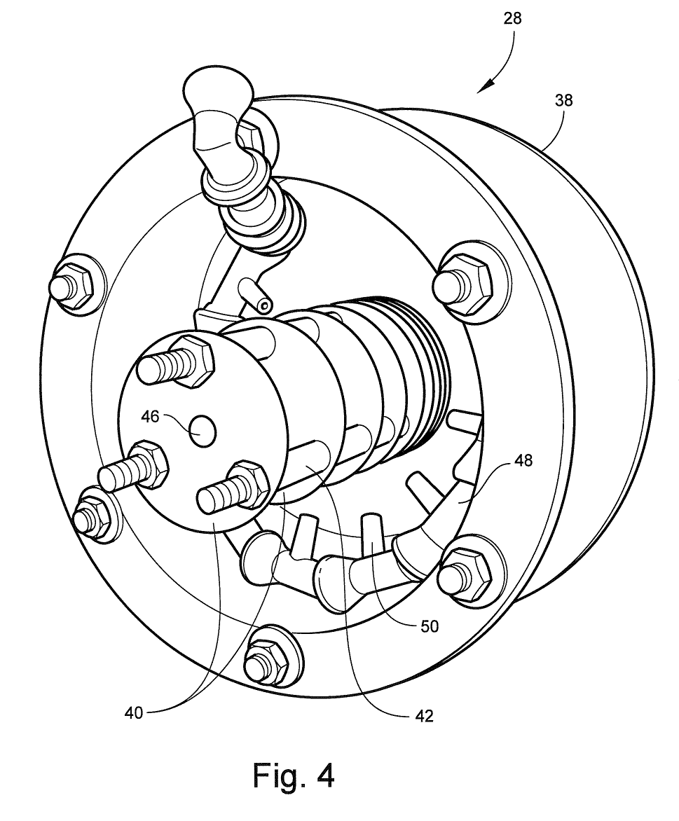

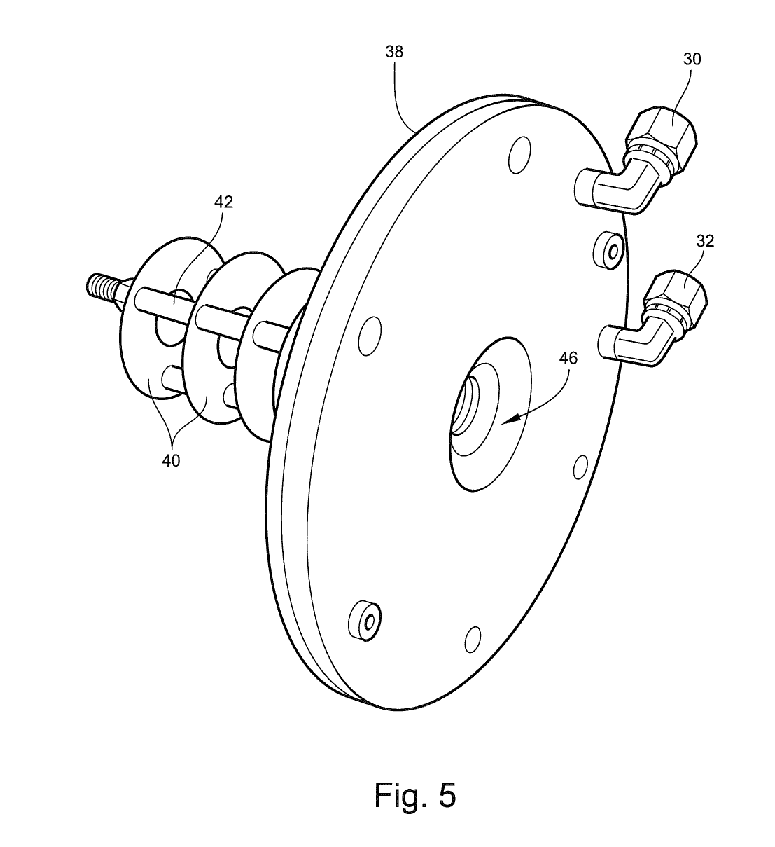

Subsequent to applying the coating, cooling occurs as the buffer tube 12 passes through an extrusion vacuum calibrator and water trough, collectively referred to as the “calibrator” and illustrated at reference numeral 28, wherein a cooling fluid is directed to the buffer tube 12 under vacuum, and the outer diameter of the buffer tube 12 is restrained against radial outward expansion. The calibrator 28 includes inlet and outlet lines 30 and 32, respectively, for introducing and withdrawing a cooling fluid. Further details of the calibrator 28 are illustrated and described below with reference to FIGS. 4-6. The cooled buffer tube 12 is then gathered onto a spool 34 or stranded into a cable, for example cable 10 shown in FIG. 1.

Referring to FIGS. 4-6, various views of the calibrator 28 are shown. The calibrator 28 includes a faceplate 38 that defines an entry side that includes an opening 46 therethrough for receiving the buffer tube 12 therethrough. The opening 46, and like openings of the plurality of downstream calibrating disks 40, have a predetermined diameter corresponding to, and preferably sized slightly larger than, the outer diameter of the coated buffer tube so as to allow the buffer tube to pass therethrough while restraining the buffer tube against outward radial expansion during curing. In an exemplary embodiment, the diameter of the opening 46 of the faceplate 38 and calibrating disks are sized about 0.025 inches larger than the outer diameter of the buffer tube.

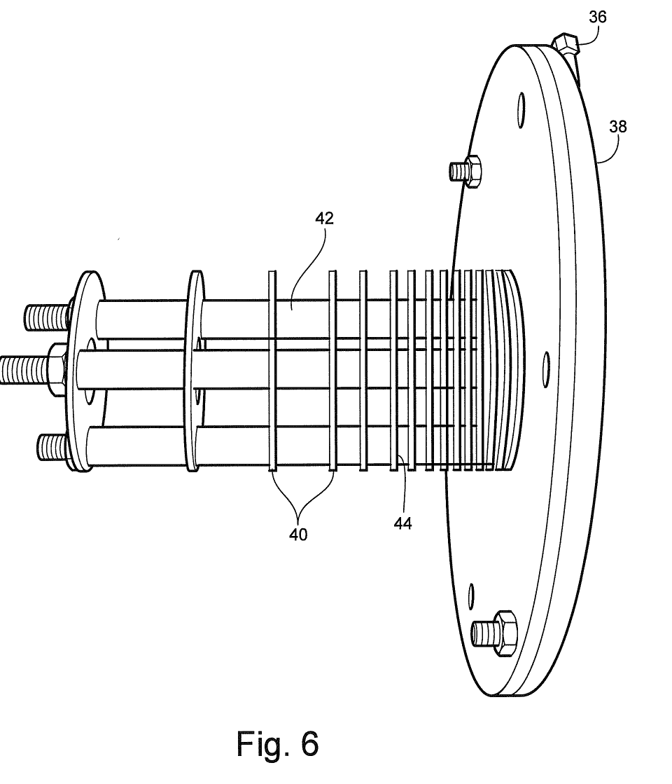

Referring specifically to FIG. 6, a plurality of calibrating disks 40 are linearly-arranged, prevented from rotation, and supported upon a plurality of support rods 42 for maintaining the disk positions relative to one another. Viewing FIG. 6 from the entry side proximate the faceplate 38, to the exit side (i.e. from the right to left), the space between adjacent disks 40 increases as curing takes place (i.e. moving downstream in the curing process) as less control over the outward radial expansion of the buffer tube is required. The predetermined space between adjacent disks 40 may be achieved using spacers, washers, etc. The disks 40 are held in place by nuts received on threaded ends of the support rods 42. In one example, the calibrator has a length of about 12 inches.

Referring again to FIG. 4, as the buffer tube passes through the calibrator 28, a cooling fluid supplied through an articulating supply line 48 is directed to the buffer tube through a plurality of nozzles 50 helically positioned around the disk arrangement. In addition to the cooling fluid, the calibrating disks 40, being positioned in close proximity to the buffer tube, may function as a thermal heat sink, and disk and faceplate materials may be chosen to optimize this function.

In an alternative method, the formed tube 20 may be closed and the tubular shape preserved using an adhesive tape. In addition to buffer tubes, the processing methods provided herein may be used to produce core wraps for cables to protect the underlying optical conductors and/or subunits. In an alternative embodiment, another method may be to pre-extrude and pre-shrink buffer tubes, then slit the tubes to inlay the fibers and inject the water blocking agents, followed by either coating the tubes and/or closing the tubes using an adhesive tape. In a further embodiment, angled cuts may be made along the edges of the formed tube at the seam to enable proper butting of the edges.

While methods of forming optical fiber buffer tubes and associated apparatus have been described with reference to specific embodiments and examples, it is envisioned that various details of the invention may be changed without departing from the scope of the invention. Furthermore, the foregoing description of the preferred embodiments of the invention and best mode for practicing the invention are provided for the purpose of illustration only and not for the purpose of limitation.

What is claimed is:

1. A method of forming an optical fiber buffer tube, comprising the steps of:
providing a length of pre-shrunk tape having a predetermined width and thickness;
forming the tape into a tube around at least one optical fiber;
coating the tube with a molten material to close and surround the tube; and
cooling the molten material to maintain the shape of the tube.

2. The method according to claim 1, wherein the step of cooling the molten material comprises passing the coated tube through a water trough under vacuum.

3. The method according to claim 2, further comprising the step of calibrating the outer diameter of the coated tube during the curing step by passing the coated tube through a series of linearly-arranged, spaced-apart calibrating disks, each of the disks defining an opening therethrough having a predetermined diameter about equal to an outer diameter of the tube subsequent to coating to restrain the coated tube against outward radial expansion during the cooling step.

4. The method according to claim 2, further comprising the step of calibrating the outer diameter of the coated tube during the cooling step by passing the coated tube through a series of linearly-arranged, spaced-apart calibrating disks, each of the disks defining an opening therethrough having a diameter slightly larger than an outer diameter of the tube subsequent to coating to limit the outward radial expansion of the coated tube during the cooling step.

5. The method according to claim 1, wherein the coated molten material has a wall thickness less than the thickness of the tape.

6. The method according to claim 1, wherein the coated molten material has a wall thickness about equal to the thickness of the tape.

7. The method according to claim 1, wherein the tape and the molten material are like materials.

8. The method according to claim 1, wherein the tape and the molten material are selected from the group consisting of polyethylene, polypropylene, polybutylene terephthalate, and polyethylene terephthalate.

9. The method according to claim 1, further comprising the step of adding a water blocking agent to an interior of the tube.

10. The method according to claim 1, wherein the at least one optical fiber is loosely encased within the tube.

11. The method according to claim 1, further comprising the step of adding colorant to the molten material.

12. The method according to claim 1, wherein the molten material surrounds the outer surface of the tube and has a generally uniform wall thickness.

13. The method according to claim 1, wherein the cooled molten material makes up about 50% or less of the total buffer tube wall thickness.

14. The method according to claim 1, wherein the cooled molten material makes up about 25% or less of the total buffer tube wall thickness.

15. The method according to claim 1, wherein the cooled molten material makes up about 10% or less of the total buffer tube wall thickness.

16. A buffer tube constructed according to the method of claim 1.

17. A buffer tube, comprising:
a inner layer formed from a length of pre-shrunk tape having a predetermined width and thickness formed into a tube around at least one optical fiber; and
an outer layer circumferentially surrounding the inner layer and holding the formed tube closed, the outer layer having a generally uniform wall thickness.

18. The buffer tube according to claim 17, wherein the wall thickness of the outer layer is less than or equal to a wall thickness of the inner layer.

19. The buffer tube according to claim 17, further comprising a water blocking agent disposed within an interior of the tube.

20. The buffer tube according to claim 17, wherein the inner and outer layers are constructed from like materials.
